(19) United States
(12) Patent Application Publication
(10) Pub. No.: US 2010/0318232 A1
(43) Pub. Date: Dec. 16, 2010

(54) METHOD FOR EVALUATING A PARTICLE SIGNAL AND SUCTION NOZZLE FOR A VACUUM CLEANER

(75) Inventors: Stefan Tiekoetter, Bielefeld (DE); Cornelius Wolf, Bielefelf (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: Miele & Cie. KG, Guetersloh (DE)

(21) Appl. No.: 12/808,775

(22) PCT Filed: Dec. 11, 2008
(86) PCT No.: PCT/EP2008/010515

§ 371 Date: Jun. 17, 2010

(30) Foreign Application Priority Data
Dec. 17, 2007 (DE) 10 2007 061 146.5

(51) Int. Cl. G05D 7/06; A47L 9/02

(52) U.S. Cl. 700/282; 15/415.1

(57) ABSTRACT

A method for evaluating a particle signal with an evaluation unit associated with a control device includes generating a particle signal by a sensor within a flow element, the particular sensor being dependent on a number of particles in a two-phase flow generated when cleaning a surface by a suction device connected to the flow control element. The method further includes determining in the evaluation unit from the particle signal a control signal for further controlling an actuator controlled by the control device. A speed of movement of the flow element over the surface is taken into account in the determination of the control signal.

### CROSS-REFERENCE TO RELATED APPLICATIONS

This application is a U.S. National Phase application under 35 U.S.C. §371 of International Application No. PCT/EP2008/010515, filed on Dec. 11, 2008, and which claims the benefit of German Patent Application No. DE 10 2007 061 146.5, filed on Dec. 17, 2007. The International Patent Application was published in German on Jun. 25, 2009 as WO 2009/077117 A1.

### FIELD

The present invention relates to a method for evaluating a particle signal by an evaluation unit associated with a control device, in which method the particle signal is generated by a sensor within a flow element and is at least dependent on the number of particles in a two-phase flow generated when cleaning a surface by a suction device connected to the flow element, and in which the evaluation unit determines a control signal from the particle signal for further controlling an actuator controlled by the control device. The present invention also relates to a suction nozzle for a vacuum cleaner for carrying out such a method.

### BACKGROUND

A method and a vacuum attachment of this type are described in EP 0 759 157 B1. That approach uses a piezoelectric sensor whose particle signals are initially conditioned and subsequently used for driving an LED display and for controlling the suction power of the vacuum cleaner. However, the amount of dust picked up, and thus the particle signal, depends not only on the suction power setting, but also on other factors.

In the approach described in DE 691 08 082 T2, the rate of change of the amount of dust, besides the amount of dust itself, is taken into account in the control of the rotational speeds of a suction fan and a brush motor. A display connected in parallel accounts only for the amount of dust itself. The theoretical basis for the described evaluation algorithm is the determination of the rate of change in the amount of dust on different floor coverings during continuous cleaning on the same spot. That approach does not account for the fact that this does not correspond to the usual procedure during vacuuming Typically, the suction nozzle used for cleaning is rather moved back and forth, so that, due to the rapid changes in position, the rate of change in the amount of dust does not provide any information about the decrease in the soil level on a particular spot, and thus no information about the floor covering. Rather, the rate of change indicates gradual differences in soil level across the entire surface passed over.

From German Patent DE 10 2006 001 337 B3, it is described to use a combination of a piezoelectric particle sensor and an optical particle sensor to determine the type of surface to be cleaned.

International publication WO 2005/077243 describes a piezoelectric sensor, a control device and an evaluation unit disposed in a connection part.

European publication EP 1 136 027 A2 describes an ultrasonic sensor.

European patent EP 0 759 157 B1 describes conditioning a particle signal by determining a peak value.

### SUMMARY

In an embodiment, the disclosure provides a method for evaluating a particle signal by an evaluation unit associated with a control device. The method comprises generating the particle signal by a sensor within a flow element, the particle signal being dependent on a number of particles in a two-phase flow generated when cleaning a surface by a suction device connected to the flow element. The method further includes determining in the evaluation unit, from the particle signal, a control signal for controlling an actuator controlled by the control device. In the method, a speed of movement of the flow element over the surface is taken into account in the determination of the control signal.

### BRIEF DESCRIPTION OF THE DRAWINGS

An exemplary embodiment of the present invention is shown in the drawings in a purely schematic way and will be described in more detail below. In the drawings:

FIG. 1 is a simplified schematic representation of a vacuum cleaner, including a suction nozzle, a suction wand, and a suction hose;

FIG. 2 is a perspective top view of a suction nozzle;

FIG. 3 is a perspective view of the suction nozzle, as seen from below; and

FIG. 4 is a block diagram.

### DETAILED DESCRIPTION

In an embodiment, there is provided a method for evaluating a particle signal, in which, in addition to the amount of dust, further influencing factors for the dust level are reliably taken into account.

In another embodiment, the disclosure provides a vacuum cleaner suction nozzle suitable for carrying out the aforementioned method.

Advantages of the method of the present disclosure are achieved in that, in addition to the particle signal, the speed with which the flow element is moved over the surface is taken into account in the determination of the control signal. This additional parameter makes it possible to obtain reliable information about the probability of dust being picked up, without the need to further evaluate the particle signal itself. This accounts for the fact that the probability of dust being picked up greatly increases when the speed of advance of the flow element is increased. This speed can be measured at a suction mouth part provided upstream of the flow element. It is possible, for example, to determine the speed from the revolutions of at least one wheel disposed on the suction mouth part.

It is advantageous if the sensor used is a piezoelectric sensor which generates signal pulses that are dependent on the kinetic energy of the particles. This enables the dust level to be detected with a high degree of accuracy, which cannot be achieved using optical sensors, for example.

It is also advantageous if the evaluation unit takes the type of surface to be cleaned into account in the determination of the control signal. As described in DE 691 08 082 T2, the dust level also depends on the floor covering being treated. However, it is better to determine and take into account the influencing factor itself than to filter it out of the signal to be influenced. The type of surface to be cleaned can be determined in a simple and reliable way by an ultrasonic transducer.

In order to give the user an indication of the progress during the cleaning of a floor surface, it is advantageous for the control device to activate a display device to display the cleaning status of the surface. Additionally or alternatively, the control device may control the suction power of the suction device and/or the intensity of a device for mechanical floor treatment located upstream of the flow element.

It is also advantageous if the speed with which the flow element is moved over the surface is utilized for driving a further display device which is used to display the optimum speed of movement for the flow element. In this manner, the user is informed of possible user errors. The optimum speed may be determined, for example, in field tests, as the speed of movement of the flow element at which the amount of particles removed from the surface is maximum. This speed may be different for different floor coverings. This is when the type of floor covering may be determined by the ultrasonic sensor described hereinbefore. Preferably, a difference between the optimum speed and the instantaneous speed may be displayed.

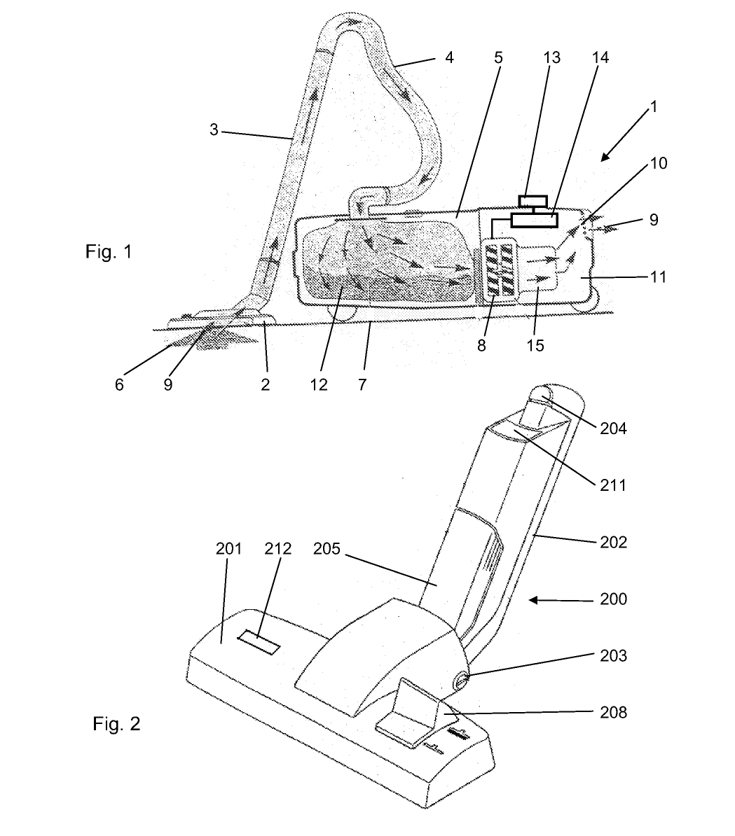

The schematic diagram of FIG. 1 shows a vacuum cleaner 1 having a suction nozzle 2, a rigid suction wand 3, and a flexible suction hose 4 attached to a dust collection chamber 5. To remove dirt 6 from a floor surface 7 to be treated, a high-speed fan 8 blows air 9 out of vacuum cleaner housing 11 through an exhaust port 10. In this process, a partial vacuum is created at suction nozzle 2, causing air 9 and dirt 6 to be drawn in therethrough as a two-phase flow and separated in a known manner in a filter bag 12 disposed in a dust collection chamber 5. Cyclone separators or other filters may be used alternatively. The suction power can be adjusted by the user using a control 13 or, alternatively, by an automatic suction control system, which will be described later herein. In either case, appliance controller 14 generates control signals for controlling the rotational speed of fan motor 15.

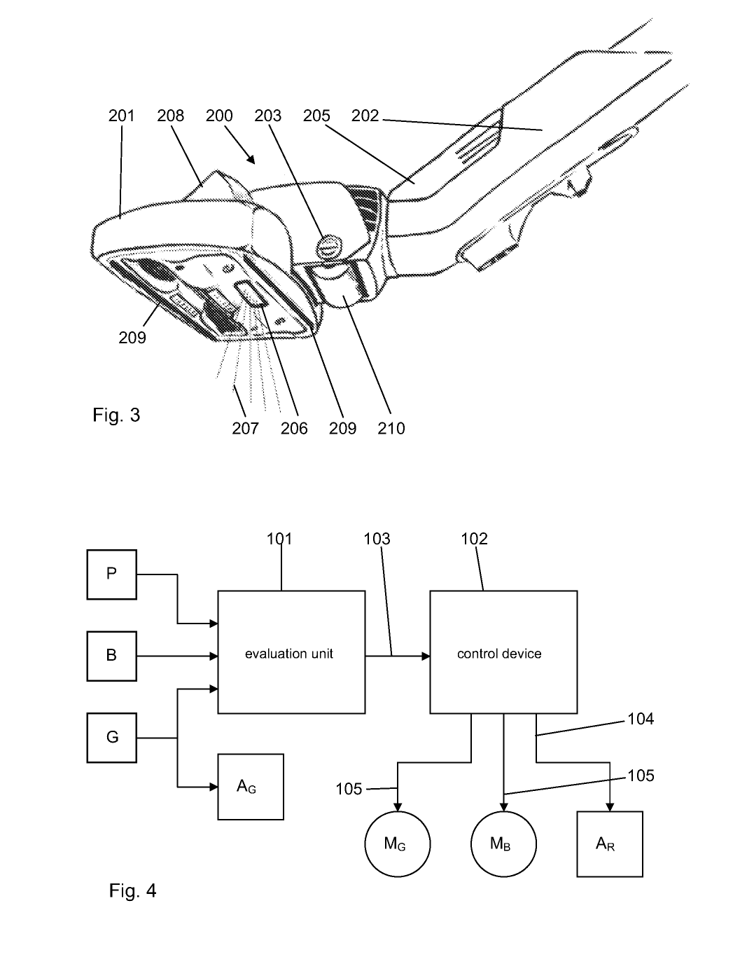

In order to carry out the method of the present disclosure, a special suction nozzle 200 is used, as is illustrated in FIGS. 2 and 3 in greater detail. In the example shown, suction nozzle 200 is a floor nozzle and is substantially formed by a suction mouth part or nozzle part 201 and a connection part 202. Nozzle part 201 and connection part 202 are typically connected to each other by a so-called “tilt and turn joint” mounted in the coupling portion. Connection part 202 is provided at its upper end with a locking lever 204 by which suction nozzle 200 can be attached to suction wand 3 of vacuum cleaner 1. Connection part 202 acts as the flow element and is equipped with a sensor 205. This sensor is used to generate a particle signal which is dependent on the number of particles in the two-phase flow composed of suction air 9 and dirt 6 generated by fan 8 when cleaning floor surface 7. Sensor 205 is a piezoelectric sensor, whose design is sufficiently known.

The method of the present invention is intended to determine the remaining density of dirt particles on floor surface 7. In particular, the method is used to measure the level of cleanliness of the floor being vacuumed, and to thereby give a user an indication of the progress of the treatment. In the process, dirt particles 6 present in the two-phase flow are drawn in through connection part 202 as the latter is moved along with suction nozzle 200 across the floor. Piezoelectric sensor 205 is disposed within connection part 202 and is acted upon by at least a portion of the two-phase flow. When a dirt particle strikes a detector surface of piezoelectric sensor 205, a portion of a kinetic energy of the particle is converted into a signal pulse. Piezoelectric sensor 205 produces an electric charge in response to deformation of its surface. The signal pulse generated in this manner is dependent on the mass and velocity of the individual particle. Consequently, the pulse provides precise information about the type, size, and velocity of the incident particle. Accordingly, a plurality of picked-up dirt particles produces a composite particle signal which is composed of individual pulses and provides information about the number of particles incident on sensor 205. This number, and thus the particle signal, is dependent on the dirt load on floor surface 7 being treated. However, there are further influencing factors that play a role in the further processing of this signal, said further factors being dependent on the probability of particles being present in the two-phase flow. These factors are the speed of advance of suction nozzle 200 and the dirt retention capacity of the particular floor covering 7. A low speed of advance results in a lower level of dust than rapid movement of suction nozzle 200. Carpets have a greater ability to hold dust than smooth floor surfaces.

In order to account for this at least to some degree, suction nozzle 200 illustrated in FIGS. 2 and 3 is equipped with a speed sensor and, preferably, with a floor covering sensor. The floor covering sensor used may be an ultrasonic transducer 206. This ultrasonic transducer transmits an ultrasonic signal 207 toward floor surface 7, and receives reflections, which may be stronger or weaker, depending on the floor covering. Based on the amplitude of these reflections, a suitable circuit can determine whether a smooth floor surface or a carpet is being vacuumed and can generate a corresponding floor covering signal. Alternatively, suitable contacts may be used to sense the position of a foot switch 208 that allows the user to adjust a ring of bristles 209 provided on suction nozzle 200 to match the particular floor covering.

In order to determine the speed with which the suction nozzle is moved over the floor surface to be cleaned, it is possible, for example, to couple wheel 210 with a pulse generator and to determine the speed of advance of nozzle 200 from the revolutions per unit time. In this manner, the pulse generator generates a speed signal.

The three signals (particle signal P, floor covering signal B, speed signal G) are transmitted to an evaluation unit 101 which generates a control signal 103 therefrom and transmits this signal to a control device 102. The signal processing is illustrated in the block diagram of FIG. 4. The control device 102 and evaluation unit 101 may be accommodated within connection part 202 as a separate control unit or be integrated within the appliance controller 14 of vacuum cleaner 1. The first alternative is useful when control device 102 only generates a control signal 104 that activates a display device A_{R} (see also display 211 in FIG. 2) to display the cleaning status of surface 7. When the intention is to generate control signals 105 and 106 for controlling the suction power by varying the rotational speed of fan motor M_{G} (see also motor 15 in FIG. 1) and for controlling control the rotational speed of motor M_{B} of a brush roller, respectively, it is useful for control device 102 to be integrated within appliance controller 14 of vacuum cleaner 1.

Particle signal P is conditioned in a known manner, for example, by determining the peak value. It is also possible to perform summation or integration. Other statistical methods for signal conditioning may also be used. The suitably conditioned signal is then compared with at least one threshold value, and control signal 103 is generated from the comparison as described hereinbelow. The description initially refers only to control signal 104 for display device A_{R}:

The quantitative characteristic of particle signal P is governed by the rate of dust removal from the floor covering being vacuumed. This is converted by the evaluation/control unit into a corresponding display:
dust removal rate very low, particle signal P very weak, display shows green,
dust removal rate low, particle signal P weak, display shows yellow or orange,
dust removal rate high, particle signal P high, display shows red.

Evaluation unit 101 continuously compares particle signal P with at least two thresholds S1 and S2 stored in the evaluation unit. When the particle signal exceeds the thresholds S1 or S2 associated with the colors yellow/orange and red, respectively, the display is activated to show the corresponding color. In practice, when determining the thresholds for the evaluation unit, one usually defines “standard conditions” or “calibration conditions”, such as, for example:
particle signal P at a vacuum attachment advance speed of 0.5 m/s,
pile goods as floor covering, for example, Wilton pile or also loop pile products.

The quantity of particle signal P depends not only on the dust removal rate on the floor covering, but to a considerable extent also on the influencing parameters mentioned above. If the vacuum attachment is moved faster, the dust removal rate per unit time will increase, and the display will tend to show yellow/orange or read sooner, whereas at lower speeds of advance, the display will switch to green too early. Both situations deviate from the standard settings, and, therefore, the soil level indicated to the user via the display according to the standard settings described above will be too high or too low. Consequently, the speed of advance of the vacuum attachment represents a disturbance variable that must be compensated for during evaluation. This is accomplished by taking the speed into account in the levels of thresholds S1 and S2 and doing so using a speed signal G. When the speed of advance is greater than 0.5 m/s, thresholds S1 and S2 are increased no more than proportionally, but preferably in a less than proportional manner, and vice versa.

Further, the quantity of particle signal P also depends on the floor covering being vacuumed. In comparison to loop pile products, cut pile products have a relatively low dust retention capacity, and, therefore, are faster to clean. Only smooth floor surfaces can be vacuumed faster in relation to cut pile products. Thus, besides the speed of advance, the floor covering is another influencing parameter that affects the dust removal rate, and thus the behavior of the display. If, due to the nature of the floor covering, the dust present on the floor covering can be removed rapidly and static thresholds are used in the evaluation unit, the high dust removal rate will tend to cause display of too high a soil level, and vice versa, which does not correspond to the real conditions. Consequently, the dust retention capacity of the floor covering represents a disturbance variable which can be compensated for if the type of floor covering present is known. This is preferably done using a floor covering sensor which is disposed in or on the vacuum attachment and which provides floor covering signal B. When the floor covering sensor detects a smooth floor surface, thresholds S1 and S2 of the evaluation unit are increased to higher levels than for pile goods, and vice versa. The range for this is preferably determined by laboratory tests.

Loop pile products, in particular, have turned out to be critical in terms of dust retention capacity because of their structure. Due to the particularly marked dust retention capacity of the loops, dirt may loosen randomly at any time during vacuuming, resulting in a flickering display. Therefore, for loop pile products, the method advantageously provides the user with the option of selecting the desired sensitivity, and thus the threshold levels, himself or herself, depending on whether rapid vacuuming progress (high thresholds) or thorough cleaning (low thresholds) is desired. This can be done, for example, using a switch provided on connection part 202.

The above-described evaluation of speed signal G and floor covering signal B and their influence on the threshold levels in the evaluation unit may be performed either individually or in combination. It turns out to be particularly advantageous to adjust the thresholds as described as a function of floor covering signal B (master) and, on this basis, using speed signal G (slave).

Advantageous methods may be derived from particle signal P alone, independently of the determination of speed and floor covering signals G, B. When particle signal P exceeds a defined level, the power consumption of the fan motor, and thus the fan speed, is increased. This method may be used, for example, in what is known as an ECO stage of the vacuum cleaner. When particle signal P is below a certain threshold, the floor covering is cleaned at reduced power and the power is increased only when a high soil level is present. Accordingly, the energy consumption varies depending on the soil level present. Moreover, the brush roller of the vacuum attachment is activated only when threshold S2 is exceeded.

The prior art describes methods in which the display of dust quantities randomly loosened from the floor covering is dependent on the definition of a time window within which a certain number of “random events” must occur. In another advantageous embodiment of the method, the length of the time window is adjusted to floor covering signal B and/or speed signal G. In the case of loop pile products and a high speed of advance, the time window is extended, and vice versa.

Speed signal G, in addition to being combined with particle signal P, can be used for driving a further display device A_{G} (see also display 212 in FIG. 2) which indicates to the user the difference between the optimum and the instantaneous speed of advance of suction nozzle 200. In this manner, the user is informed of possible user errors. The optimum speed may be determined, for example, in field tests, as the speed of movement of the flow element at which the amount of particles removed from the surface is maximum. This speed may be different for different floor coverings. This is when the type of floor covering may be determined by the ultrasonic transducer 206 described hereinbefore.

While the invention has been described with reference to the particular embodiments thereof, it will be understood by those having ordinary skill in the art that various changes may be made therein without departing from the scope and spirit of the invention. Further, the present invention is not limited to the embodiments described herein; reference should be had to the appended claims.

1. A method for evaluating a particle signal by an evaluation unit associated with a control device, the method comprising:
generating the particle signal by a sensor within a flow element the particle signal being dependent on a number of particles in a two-phase flow generated when cleaning a surface by a suction device connected to the flow element (202), and
determining in the evaluation unit, from the particle signal, a control signal for further controlling an actuator controlled by the control device,
wherein in addition to the particle signal, a speed of movement of the flow element over the surface is taken into account in the determination of the control signal.

2. The method as recited in claim 1, further comprising measuring, at a suction mouth part disposed upstream of the flow element, the speed of movement of the flow element.

3. The method as recited in claim 2, wherein the speed of movement of the flow control element is determined from the revolutions of at least one wheel disposed on the suction mouth part.

4. The method as recited in claim 1, wherein the sensor includes a piezoelectric sensor configured to generate signal pulses that are dependent on a kinetic energy of the particles.

5. The method as recited in claim 1, wherein the evaluation unit takes a type of the surface into account in the determination of the control signal.

6. The method as recited in claim 6, wherein the type of the surface is determined by an ultrasonic transducer.

7. The method as recited in claim 1, further comprising activating a display device with the control device so as to display a cleaning status of the surface.

8. The method as recited in claim 1, further comprising controlling, by the control device, a suction power of the suction device.

9. The method as recited in claim 1, further comprising controlling, by the control device, an intensity of a device for mechanical floor treatment disposed upstream of the flow element.

10. The method as recited claim 1, further comprising utilizing the speed of movement of the flow element over the surface for driving a further display device so as to display an optimum speed of movement for the flow element.

11. A suction nozzle for a vacuum cleaner, comprising a sensor disposed within a flow element and configured to determine a particle signal dependent on a number of particles in a two-phase flow generated when cleaning a surface, and
a device configured to determine a speed of movement of the suction nozzle over a surface to be cleaned.
